(19) United States
(12) Patent Application Publication
(10) Pub. No.: US 2012/0057346 A1
(43) Pub. Date: Mar. 8, 2012

(54) Vertical & Horizontal Blinds with Lighting

(76) Inventor: Roeland Jan Spanjaard, Cadier en Keer (NL)

(21) Appl. No.: 12/597,935

(22) PCT Filed: Apr. 4, 2008
(86) PCT No.: PCT/NL08/00121

§ 371 Date: Apr. 19, 2010

(30) Foreign Application Priority Data
May 10, 2007 (NL) 1033785

(51) Int. Cl. F21V 21/008

(52) U.S. Cl. 362/249.02

(57) ABSTRACT

The invention is based on a certain number of hollow translucent vertical blinds (1), which are somewhat ovally profiled, wherein LED-lights or another light source (3) has been fixed and on top and bottom of the vertical blinds are bolted by a lock-cap, provided with a light source (3), or LED lights, where of both light sources independently from each other can be linked, so that special light effects can be realised in the hollow translucent vertical blinds and bolted lock caps into the top and bottom of the vertical blinds.

The invention is based on a certain number of hollow translucent vertical blinds, which are somewhat ovally profiled, wherein LED-lights or another light source has been fixed and on top and bottom of the vertical blinds are bolted by a lock-cap, provided with a light source or LED lights, where of both light sources independently from each other can be linked, so that special light effects can be realised in the hollow translucent vertical blinds and bolted lock caps into the top and bottom of the vertical blinds.

Current vertical and horizontal blinds consist of singular thin plate material. In case an image is fixed on the surface or is put against the closed structure of the blinds, can this be only realized by paintbrush or serigraphy. Besides, these blinds aren't utilizable for lighting, light sources cannot be assembled into singular thin plate material.

From the European Patent-Book EP 0 569 326 have been confessed, that hollow blinds exist. They are prism-moulded and inside constructed with an oblong light source but without the possibility to create special light effects.

Vertical blinds, like this invention, try to annul this disadvantage, by using light sources which exist of an amount of LED-lights or has been based on another light-technique, assembled into the hollow vertical blinds.

It prefers also to provide the transparent vertical blind with one or two interchangeable printed sheets with images from the inside, while preferably every vertical blind on top and bottom is bolted by a lock-cap, supplied with a light source of LED lights.

Also it has the preference, that the light sources in every vertical and in every lock cap can be linked independently of each other.

It is also preferred that every vertical has been made, of massive light conducted material and on top and bottom bolted with a lock cap, wherein a light source is fixed.

Preferably the hollow light-permeable blinds of hollow, equilateral triangle consist of a rotatable light core.

The invention will be explained according the following pictures:

Picture 1 shows the cross-section of a hollow vertical;

Picture 2 shows lock caps from top and bottom side of the vertical;

Picture 3 shows a vertical designed in massive, light conductible material;

Picture 4 shows a vertical in the shape of a prism.

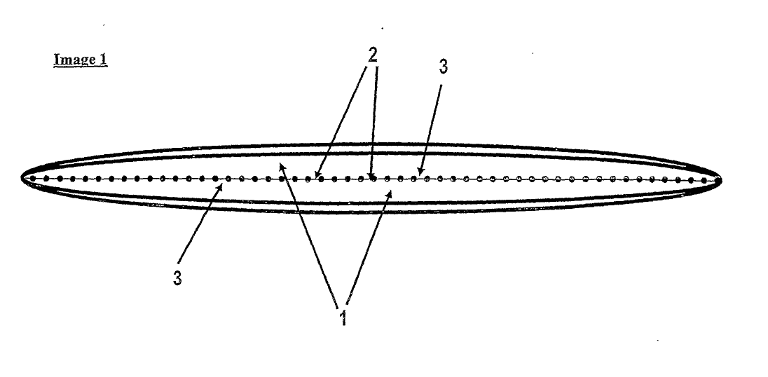

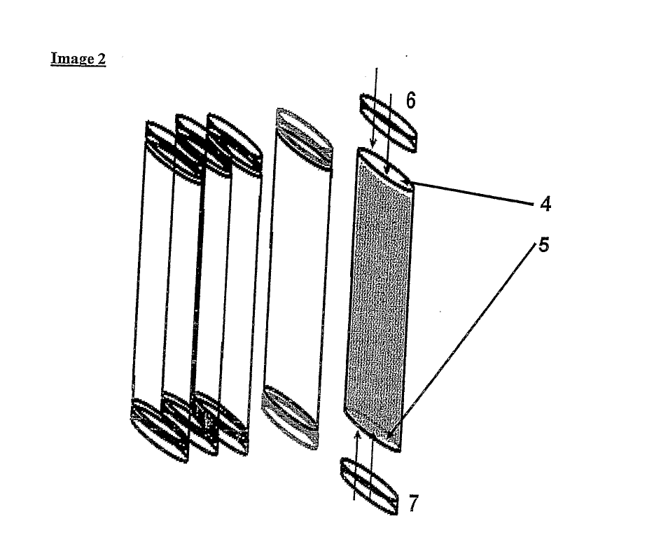

The vertical, in accordance with the invention, consists of a long, hollow somewhat ovally profiled vertical 1, that has been made of light translucent material. The hollow vertical 1 consists of a mantle of PMMA (=polymethylmethacrylaat), glass or another light translucent material at least with the same optical qualities. Across the whole length, inside the vertical 1, a partition 2 has been constructed, that on both sides is provided with a light source 3. Every light source 3 consists of a certain light source or an amount of LED-lights. For obtaining the most optimum impact, the partition 2 has been carried out in a non-transparent or not light permeable material. This is shown in FIG. 1. The number of LEDS or another light source fixed on the partition 2, dependent of the length of the vertical 1, as light-intensity and/or color. At the top 4 and bottom 5 of the vertical 1, the hollow vertical 1 has been bolted with a lock-caps 6 and 7. As shown in image 2.

The second design of the vertical has a lock-cap 6 on top 4, and a lock-cap 7 in the bottom 5, supplied with a light source 8 & 9, consisting of LEDS, been applied in translucent or in opaque material. The wiring consists of voltage supply for a light source 3, and voltage supply for LEDS 8 and 9 of the lock-caps 6 and 7, so that all the light sources are independent and separately linked from each other.

The hollow oval-shaped verticals 1 have a front side and back side, whereof every side can be provided with an individual pattern, image and/or texture, that complements the design. According the application, the images can be eventually shown like a whole picture, because side by side these verticals 1 form a tightly closed front.

It's possible to fix an image permanently on these hollow transparent verticals 1 or printed images like interchangeable sheets, that can be slid out of the inside of the hollow verticals 1 or, interchangeable sheets on the outside.

With hollow and transparent vertical blinds 1 the possibility exists to fix or to carry out the image permanently as interchangeable foils or sheets, which can be slid into the inside of hollow verticals 1 or to the outside.

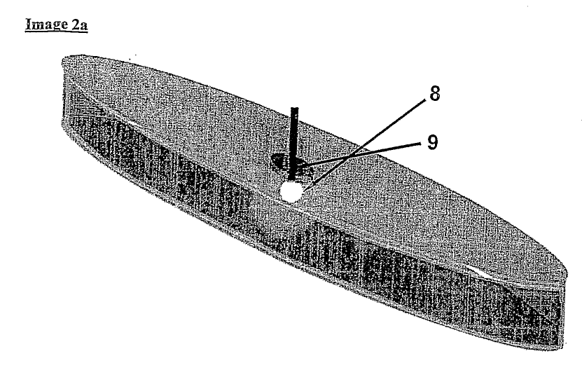

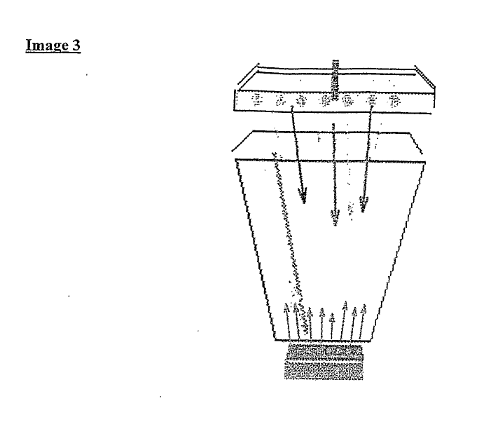

A third implementation of the invention, as shown in FIG. 3, is related on a composition of a number narrow, long, rectangular vertical blinds or plates of a certain thickness, that has been made of massive, light permeable and light-conductive material, such as for example massive glass or acryl glass/Plexiglas, whereat is used, the light conductive properties of the massive material.

The top and bottom side of every vertical 1 has been provided with lock caps 6 and 7, either, made of light-permeable or non transparent material and a light source 8 and 9 that illuminates in conductive manner, through all the massive, light-permeable, light-conductive verticals 1, whereby every vertical 1 diffuses light.

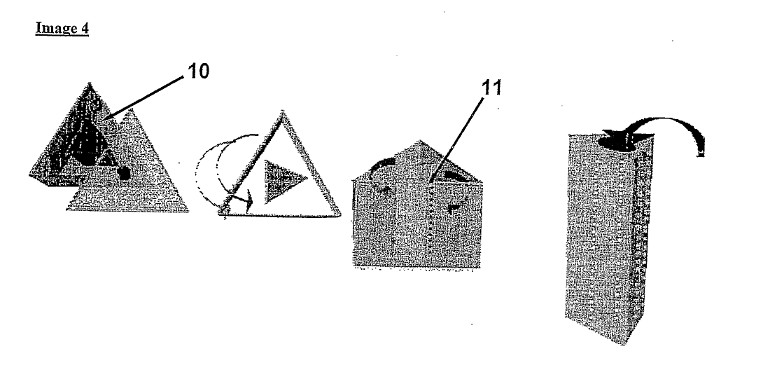

In a fourth implementation, as shown in FIG. 4, the hollow equilateral triangles are built from vertical blinds 1, whereby inside the hollow spaces 10 a rotating light core 11 has been fixed, so that three different light-effects and images are possible.

The vertical blind system according to the invention can be hung also horizontally by using an adapted rail system, whereby the blinds can be rotating in the left and right side of that rail system.

1. Vertical blind system for presenting information, which consists of a rail system and hollow, light-permeable vertical blinds, and provided with an internal light source with the characteristic, that the light source (3) in the hollow vertical blind (1) consists of a large number of LEDS or another light source assembled to a partition (2) in the vertical blind (1).

2. Vertical blind system, according to the conclusion 1, with the characteristic, that the light-permeable vertical blind (1) has been provided to the inside with one or two interchangeable sheets with images.

3. Vertical blind system, according to the conclusion 1 or 2, with the characteristic, that every vertical blind (1) to the top and bottom side has been bolted with a lock cap (6;7) wherein a light source (3) is fixed that consists of an amount of LEDS or another light source.

4. Vertical blind system, according to one of the preceding conclusions, with the characteristic, that the light sources (3) in every vertical blind (1) and in every lock cap (6;7) can be linked independently from each other.

5. Vertical blind system, according to one of the preceding conclusions with the characteristic, that every vertical blind (1) has been carried out in massive, light conductive material and into the top and bottom side it has been bolted with a lock cap (6;7), wherein a light source (8;9) has been fixed.

6. Vertical blind system, according to one of the preceding conclusions with the characteristic, that these hollow light-permeable vertical blinds (1) consist of a hollow, equilateral triangle with a rotatable light core (11).
